(19) United States
(12) Patent Application Publication
(10) Pub. No.: US 2018/0340865 A1
(43) Pub. Date: Nov. 29, 2018

(54) Swab Sampling Apparatus and Methods

(71) Applicant: FLIR DETECTION, INC., Stillwater, OK (US)

(72) Inventors: Dennis Barket, JR., West Lafayette, IN (US); James Mitchell Wells, West Lafayette, IN (US)

(21) Appl. No.: 14/996,021

(22) Filed: Jan. 14, 2016

Related U.S. Application Data
(60) Provisional application No. 62/103,265, filed on Jan. 14, 2015.

(51) Int. Cl. G01N 1/04

(52) U.S. Cl. CPC G01N 1/04; G01N 2001/028

(57) ABSTRACT

Sampling wands are provided that have features added to improve the collection of trace residues from surfaces, and also features to improve the release of the sampled residue into a detection system. The improved features include, but are not limited to a system to deliver solution or other reagents onto the sampling ticket before sampling to improve the collection of residues through enhanced release of particles from the surface, dissolution of the residue, and/or increased adherence of the residue to the ticket, and a system to deliver solution or other reagents after sampling but before analysis to improve release of the residue into the detection system.

### CROSS REFERENCE TO RELATED APPLICATION

This application claims priority to U.S. Provisional Patent Application Ser. No. 62/103,265 which was filed on Jan. 14, 2015, the entirety of which is incorporated by reference herein.

### TECHNICAL FIELD

The field of the invention is related to swab ticket sampling and methods and apparatus used for same.

### BACKGROUND

Sampling of trace residues using a physical medium, i.e. a sampling swab or ticket, is common in security applications to screen for the presence of illicit materials such as explosives or narcotics. The sampling ticket is used to wipe the surface of articles, such as a box, carton, suitcase, briefcase, purse, laptop computer, or a subject's hands, to collect trace particles and other residues of material that may have been handled during illicit activity and then transferred to the article. The sampling ticket is then inserted into an analysis device, such as an ion mobility spectrometer or a mass spectrometer, and the residues are analyzed to look for the presence of target materials. Targets may include explosives, narcotics, or other materials of interest.

Many of the materials of interest are difficult to sample, due to strong adhesion to the surfaces, and are also difficult to release from the sampling ticket for the same reason. Also, release from the sampling ticket is accomplished via heat (thermal desorption), and many explosives, e.g. potassium perchlorate or urea nitrate, have extremely high melting and boiling points.

### SUMMARY

Sampling wands are provided that have features added to improve the collection of trace residues from surfaces, and also features to improve the release of the sampled residue into a detection system.

The improved features include, but are not limited to a system to deliver solution or other reagents onto the sampling ticket before sampling to improve the collection of residues through enhanced release of particles from the surface, dissolution of the residue, and/or increased adherence of the residue to the ticket, and a system to deliver solution or other reagents after sampling but before analysis to improve release of the residue into the detection system.

### DRAWINGS

Embodiments of the disclosure are described below with reference to the following accompanying drawings.

FIG. 1 is a perspective view of a sampling apparatus according to an embodiment of the disclosure.

FIG. 2 is a perspective view of a sampling apparatus according to an embodiment of the disclosure.

FIG. 3 is a cross sectional depiction of a sampling apparatus according to an embodiment of the disclosure.

FIG. 4 is an illustration of a sampling apparatus in use according to an embodiment of the disclosure.

FIG. 5 is an illustration of a ticket coupling assembly portion of a sampling apparatus in one configuration according to an embodiment of the disclosure.

FIG. 6 is an illustration of the ticket coupling assembly of FIG. 5 in another configuration according to an embodiment.

### DESCRIPTION

This disclosure is submitted in furtherance of the constitutional purposes of the U.S. Patent Laws “to promote the progress of science and useful arts” (Article 1, Section 8).

The sampling wand used with trace detection instruments may be a handheld device that is used by a screener to sample (see the Figure), or it may be an automated sampling machine (robot) that holds the ticket and moves it around the surface being sampled.

Sampling with the wand involves wiping over a surface (substrate) with the sampling swipe to physically collect residues onto the sampling ticket. The efficiency of particle collection from the surface will be determined in part by the relative tendency of particles to adhere to the surface of the substrate vs. the sampling swipe. Particles can be loosened from the substrate using a solution to wet the particles and reduce adhesion forces. Sampling with a solutioned swipe can have benefits for collecting particles of some target materials. For targets that are present on the surface as a film or homogenous residue, rather than as individual particles, the wet swipe will help collect the material by solubilizing it and removing it from the substrate and onto the swipe. In both cases, a method for introducing solution to the sampling swipe is desired.

Sampling wands are provided that can include a reservoir of solution, tubing, and a mechanism to allow the operator or sampling machine to introduce a solution onto the sampling ticket prior to using the swipe. The solution may be an organic solvent, e.g. methanol, hexane, acetone, or water, or a mixture of organic solvents or water. A solution may also contain reagents that will react with targets to reduce their adhesion and/or better dissolve them for collection.

To analyze the sampled material, the sampling ticket can be introduced into the detection system, and the targets are thermally-desorbed from the ticket. The desorbed vapors are transported into the detector for analysis. For some targets, the temperatures necessary to efficiently desorb from the ticket are too high to practically achieve in a detection system. The wand described herein can overcome this by having a reservoir for holding solution and/or other reagents that can be applied to the sampling ticket after the sample is collected and before it is introduced into the detection system. Solutions and reagents could be any material found to enhance desorption of target material, e.g. crown ethers and certain carbohydrates have been found to enhance desorption of some explosive targets. The reservoir, the tubing, and the means for applying a solution or reagent may be the same as those used to enhance sampling, or they may be a different set of hardware in the same wand.

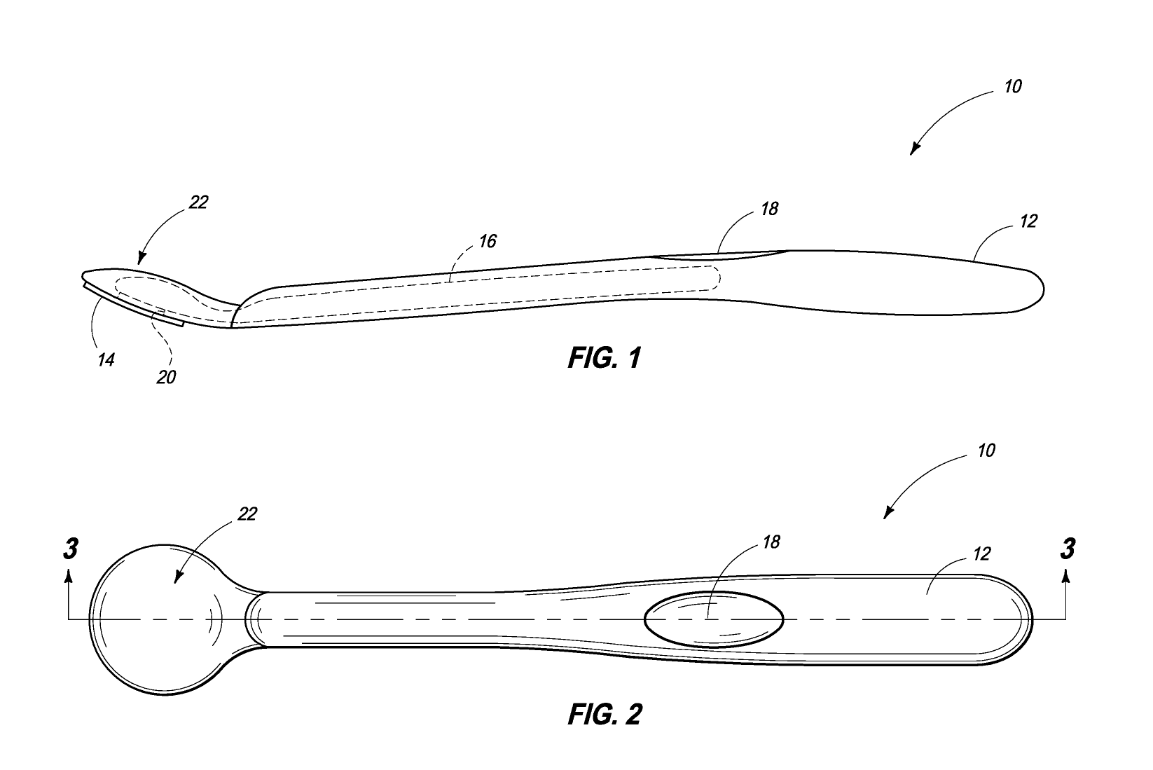

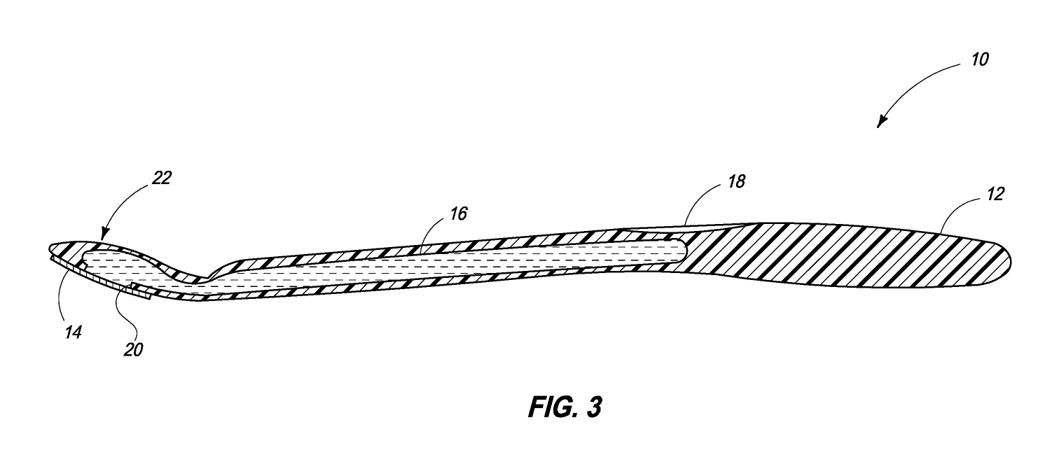

With reference to FIGS. 1-6, a wand apparatus 10 of the present disclosure is provided. Wand apparatus 10 can include a handle portion 12 such as an elongate member extending to a head portion 22 (one end) that can be configured to reversibly couple with a swab sampling ticket 14. These swab sampling tickets as described herein are utilized in conjunction with the wand to sample materials and for the purposes of identifying analytes of interest (targets). Apparatus 10 can include a reservoir 16 in fluid communication with portion 22 and that can be utilized to confine a solution. This solution can be provided from reservoir 16 to sampling swab ticket 14. This can facilitate the more efficient sampling of analytes of interest.

Reservoir 16 can be operatively coupled with and/or in fluid communication with pressure differentiation assembly 18 that facilitates the providing of a solution within reservoir 16 to swab ticket 14. Assembly 18 can include a cover that when unbiased resides consistently along the outline of the elongate member. Assembly 18 can be utilized to facilitate the transfer of fluid to the swab ticket 14. Pressure differentiation assembly 18 can be a plunger or mechanically pressure differential device such as a pliable or biased component of handle portion 12, for example. Assembly 18 can include a flexibly resilient member configured to provide air pressure to the reservoir upon mechanical pressure and acquire air upon release of mechanical pressure. A one-way valve 20 may be configured to release pressurized fluid from within reservoir 16 and to swab ticket 14. According to other embodiments, head portion 22 may include an interface associated with valve 20 that allows for a semipermeable transfer or pressure transfer for distribution of solution within reservoir 16 to swab ticket 14. Accordingly, this interface can be configured to receive fluid from the reservoir via the one-way valve and disperse same upon ticket 14. The interface can also be formed to provide a seat for the ring of the coupling assembly described below.

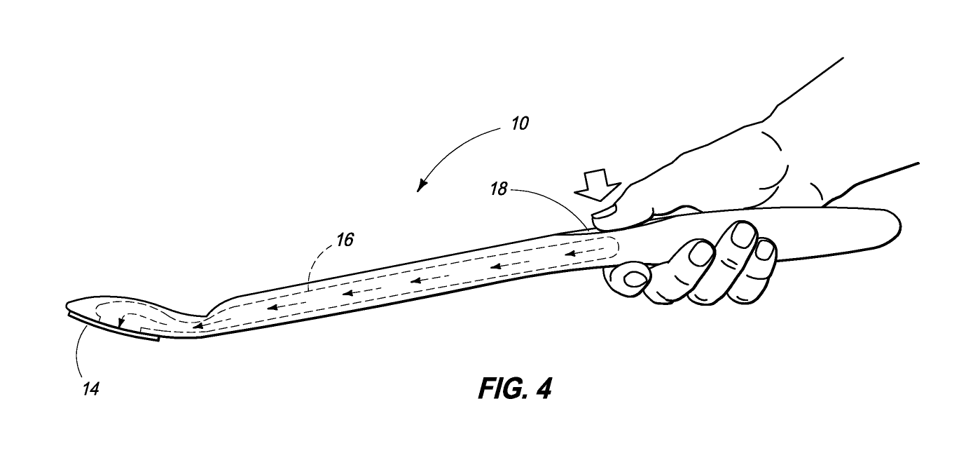

Referring to FIG. 4, after providing a swab ticket and reversibly coupling same to the sampling wand, a screener may activate assembly 18 to facilitate the dispensing of solution from the reservoir 16 to the swab 14. According to an embodiment of the disclosure, the screener may digitally manipulate the assembly 18 with a thumb, providing solution from the reservoir to the sampling swab ticket, while contacting a substrate surface with the swab ticket 14. In accordance with example embodiments, a pliable portion of the pressure differentiation assembly can be mechanically compressed to pressurize the liquid reservoir. The pliable portion can return to an uncompressed state upon releasing pressure.

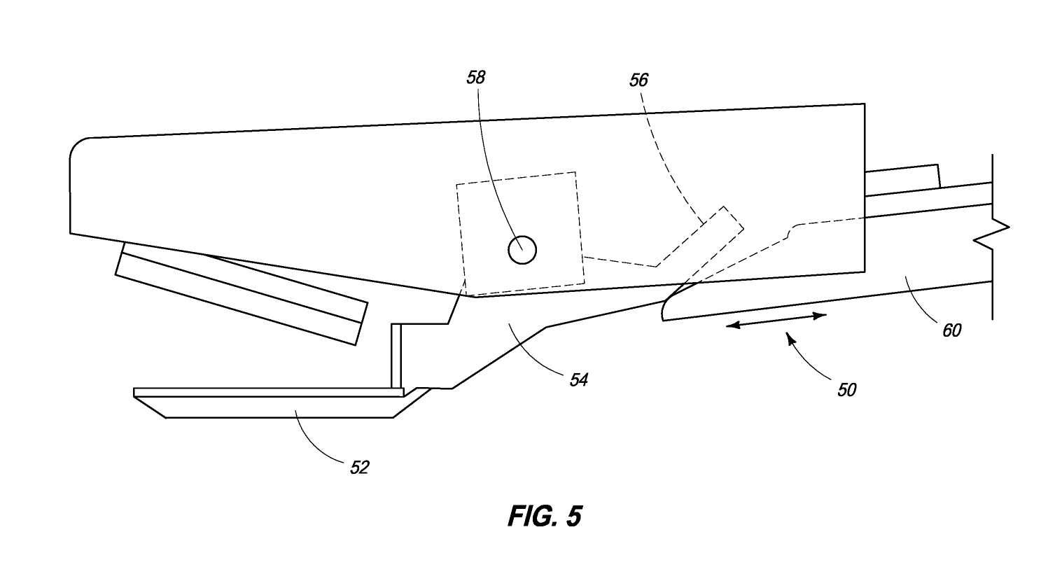

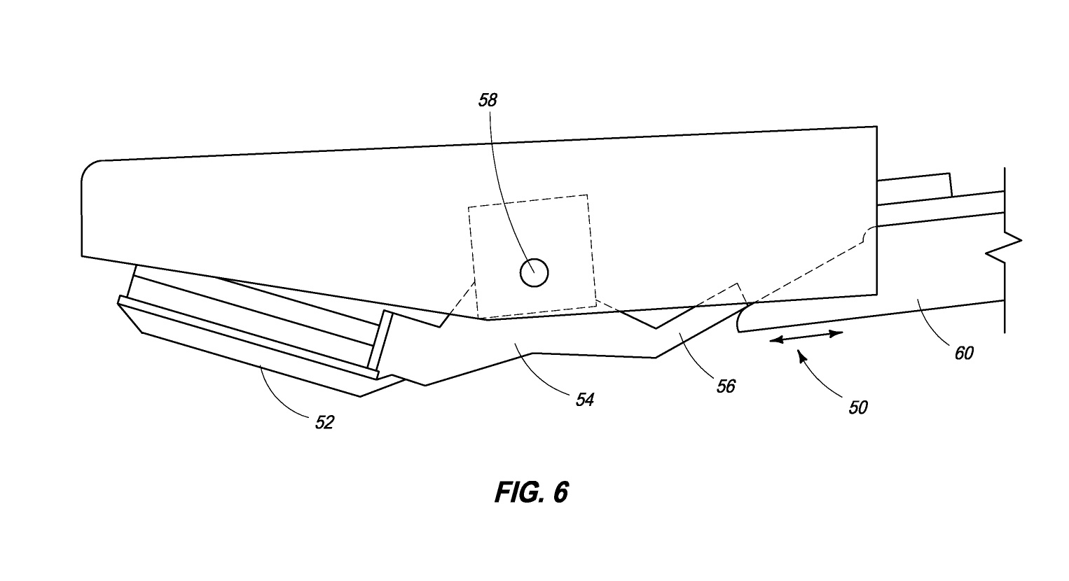

Referring next to FIGS. 5 and 6, ticket coupling assembly 50 is shown in two configurations according to embodiments of the disclosure. In FIG. 5, the assembly is configured to receive or release a swab sampling ticket, and in FIG. 6 the assembly is configured to couple a swab sampling ticket. Assembly 50 includes a member extending from 52 through 54 to end 56. End 52 can be configured as an open ring having a circumference less than the circumference of a swab ticket. The ring can be configured to be seated when coupling a swab ticket against the sampling wand. The member can be biased in the seated configuration show in FIG. 6 with a biasing member such as spring operatively engaged with axle or pivot member 58. Axle 58 can operatively engage portion 54 having an opening configured to receive axle 58 and pivot between the two configurations. Assembly 50 can include slide member 60 that can be pressured toward the ticket to a catch, lifting end 52 against the bias to release and/or receive a ticket in the configuration of FIG. 5. Slide member 60 can be released from the catch and bias can return member 52 to the seated position to couple the sample ticket. Upon sampling, swab ticket 14 can be transferred to an analytical device such as described in U.S. patent application Ser. No. 13/811,580.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A swab sampling wand apparatus comprising:
an elongate member extending between two ends, one of the two ends configured to couple with one side of a sampling swab ticket;
a reservoir defined within the member and in fluid communication with the one of the two ends and the one side of the sampling swab ticket when so coupled; and
a pressure differentiation assembly in communication with the reservoir.

2. The apparatus of claim 1 wherein the reservoir is configured to contain a solution.

3. The apparatus of claim 2 wherein the solution comprises one or more of water, methanol, hexane, and/or acetone.

4. The apparatus of claim 1 wherein the pressure differentiation assembly comprises a flexibly resilient member configured to provide air pressure to the reservoir upon mechanical pressure and acquire air upon release of mechanical pressure.

5. The apparatus of claim 1 further comprising a one-way valve associated with the one end and configured to release pressurized fluid from the reservoir to the one side of the sampling swab ticket.

6. The apparatus of claim 5 further comprising an interface between the one end and the one-way valve.

7. The apparatus of claim 6 wherein the interface is configured to receive fluid from the reservoir via the one-way valve and disperse the fluid to the one side of the sampling swab ticket.

8. The apparatus of claim 1 further comprising a coupling assembly associated with the one end of the member and configured to releasably couple the sampling swab ticket.

9. The apparatus of claim 1 wherein the pressure differentiation assembly comprises a cover when coupled to the member extends consistently with the walls of the member.

10-20. (canceled)

21. The apparatus of claim 1 wherein the member defines a substantially planar portion configured to engage a planar portion of the sampling swab ticket.

22. The apparatus of claim 21 wherein the swab sampling ticket is coupled to the planar portion of the member,

23. The apparatus of claim 21 wherein the planar portion is defined along a lateral portion of the member.

24. The apparatus of claim 21 wherein the sampling swab ticket is coupled to the planar portion of the member along the lateral portion of the member.
